(19) United States
(12) Patent Application Publication
(10) Pub. No.: US 2026/0180892 A1
(43) Pub. Date: Jun. 25, 2026

(54) SYSTEM FOR SECURE AND PRIVATE DATA TRANSFER

(71) Applicant: BRING YOUR, INC., PALO ALTO, CA (US)

(72) Inventor: BRIEN COLWELL, REDWOOD CITY, CA (US)

(21) Appl. No.: 18/464,953

(22) Filed: Sep. 11, 2023

(51) Int. Cl. H04L 45/12; H04L 9/40; H04L 45/42

(52) U.S. Cl. CPC H04L 45/123; H04L 45/42; H04L 63/0435

(57) ABSTRACT

A system provides secure transfer of encrypted data between endpoints with resistance to external attacks. A management platform coordinates operation of many nodes, such as end user devices that have agreed to participate. A client initiates a request with the platform to send data to a destination. The platform selects a low-latency multi-hop route using many nodes. An address of a first node in the route is provided to the client. Each node in the route is provided with next hop data and contract data for that session. During the session, data is sent from the client to the first node, and then to other nodes in the route and ultimately the destination. Upon conclusion of the session, the contract is closed and payment may settle. The contract may be closed by any participant due to violation of operating parameters, terminating the session.

### BACKGROUND

Data transferred between networked devices may be prone to interception, blocking, or other attacks.

### COMPUTER PROGRAM LISTING APPENDIX

This disclosure incorporates by reference the material submitted in the Computer Program Listing Appendix filed herewith. The material within the Computer Program Listing Appendix is Copyright 2023 BringYour, Inc. or its affiliates, all rights reserved.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features. The figures are not necessarily drawn to scale, and in some figures, the proportions or other aspects may be exaggerated to facilitate comprehension of particular aspects.

FIG. 1 illustrates a system comprising nodes and a platform to facilitate secure and private data transfer, according to some implementations.

FIG. 2 illustrates use of an extender node to relay traffic to the platform, according to some implementations.

FIG. 3 illustrates data associated with operation of the system, according to some implementations.

FIG. 4 depicts a flow diagram of a process to provide secure and private data transfer, according to some implementations.

FIG. 5 illustrates operation of the system to establish secure communication, according to some implementations.

FIG. 6 illustrates providing remuneration during operation of the system, according to some implementations.

FIG. 7 depicts a flow diagram of a process to provide remuneration, according to some implementations.

FIG. 8 depicts a flow diagram of a process to cancel communication service associated with detected abusive behavior, according to some implementations.

FIG. 9 depicts a flow diagram of a process for a node to relay encrypted traffic, according to some implementations.

FIG. 10 depicts route selection from available node devices, according to one implementation.

FIG. 11 is a block diagram of a computing device of the system, according to some implementations.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Transfer of data between devices on a wide area network such as the internet is a critical part of how the world works today. This data may range from the mundane such as sports scores and entertainment to the critical such as health care data and commands to complex industrial control systems. Maintaining the security and privacy of this data is an ongoing battle between security professionals and adversaries. Adversaries may wish to acquire this data, or inject their own, while users wish to keep this information secure. Traditionally, small companies or individual users have been at a disadvantage when attempting to maintain secure transfer of data. For example, small companies or individuals typically do not have access to individuals with extensive security expertise who are constantly managing a secure network, and the cost to maintain such as secure network is prohibitive.

Described in this disclosure is a system for secure and private transmission of data. The system provides a robust resistance to external attacks such as eavesdropping, man-in-the-middle (MITM), denial of service, traffic analysis, and so forth. The system uses a set of node devices that are registered with a platform that manages operation. These nodes provide various functions, such as relaying encrypted traffic. Nodes may select what roles or functions they wish to provide. For example, a node may only act as an endpoint, may relay data for other users, and so forth.

Each node may be independently owned and operated by different individuals or other entities. Nodes may comprise commercially available hardware that may be performing other functions while also participating in the system. For example, nodes may comprise smartphones, laptops, and so forth that are owned by separate individuals. As described in this disclosure, these nodes may be used as part of the system to provide secure communication to users.

A user provides remuneration, such as a transfer of cash, cash equivalent, cryptocurrency, and so forth to their corresponding account of the platform. When the user wishes to establish a secure connection, their initiating node sends a connection request to the platform. The connection request may specify destination information for the connection. The address of the initiating node may be included in the connection request or determined based on other data.

Responsive to the connection request, the platform determines which participating nodes are available to relay traffic or provide other functions associated with the request. The platform then determines a route from the originating request to the destination information using a plurality of the participating nodes. The route may have a minimum number of relays, or “hops”. For example, the route may be determined using a multi-hop linear path algorithm as described herein. In some implementations the route may be determined based at least in part on information in the connection request, such as a requested egress within a particular geographic area or within a particular network.

Once a route has been determined, one or more contracts are determined. In one implementation a single contract may be used across all nodes that are involved in the secure communication. In another implementation separate contracts may be sent to individual nodes that are involved in the secure communication. Each contract provides information that is used to provide remuneration for facilitating the secure communication. For example, the contract may comprise a contract identifier.

With the route and contracts set, remuneration may be transferred to an escrow account. For example, contract escrow allocated remuneration that is associated with providing the communication service may be transferred from an initiating account to node escrow accounts. In some implementations, a minimum amount may be placed in escrow. Each node escrow account is associated with a node specified in the route. A contract may be closed by any node in the route. Contract closure may be normal or result from detection of abusive behavior. Once the contract is closed normally, the accounts may be settled, with any unearned remuneration being returned to the initiating account. In the event of a violation of service terms, such as resulting from abusive behavior, the remuneration in escrow may be forfeited. This forfeiture acts as a disincentive against abusive behavior.

The platform sends control data to the nodes that are participating. The control data may include route data and the contract data. The route data may comprise a portion of the route, such as a next address or “next hop” that the encrypted traffic is to be relayed to. In some implementations, the route data provided to individual nodes does not include the entire route.

The initiating node may then send encrypted traffic to a first participating node, which in turn relays that encrypted traffic to a second participating node, and so on until a final participating node, acting as the egress, sends the encrypted traffic to a destination address.

Communication provided by the system described herein may be bidirectional. For example, the initiating node may send encrypted traffic to a destination computing device at the destination address, and the destination computing device may send encrypted traffic to the initiating node.

In some implementations, separate routes or contracts may be used for different flows of encrypted traffic. For example, a first contract and first route may be used to send encrypted traffic from the initiating node to the destination computing device, while a second contract and second route may be used to send encrypted traffic from the destination computing device to the initiating node.

Instead of, or in addition to relaying encrypted traffic, the nodes may provide other functions. In one implementation, a node may act as an “extender” to relay communication associated with the platform. For example, a node may receive a connection request from an initiating node and relay the connection request to the platform. The extender may allow the platform to continue operation in the event of a denial-of-service attack, erroneous or malicious filtering of network traffic to the platform, and so forth.

By using the system and techniques described herein, security, privacy and resilience to attack are substantially improved for communications on a network such as the internet. Data provided to individual nodes is limited. For example, a node in the route that is relaying encrypted traffic has no information about the initiating node or the destination computing device. As a result, compromise of a single node provides little or no usable information to an attacker.

Because the relayed traffic is encrypted, and the relaying node is not privy to the cryptographic credentials, the node is unable to decrypt the payload and has no visibility into the payload. Individual nodes may be located at different physical locations in the physical world, allowing egress of traffic at a desired locale. Individual nodes may be located on different networks (or subnetworks) in different address locations in the network, allowing egress of traffic from one or more egress nodes having a desired network, address range, and so forth.

The system may be configured to require remuneration to use. Abusive behavior may result in mitigating actions, such as terminating the associated account or forfeiture of the remuneration. This provides direct and negative feedback to a bad actor, increasing the cost of such attempts. The remuneration to nodes provides an incentive for nodes to participate in the system. This allows the system to readily scale to large numbers of nodes without traditional costs associated with the system maintaining physical hardware. This ability to scale improves the capacity of the system to service users, while also increasing privacy and security by increasing the number of possible routes, extender provided addresses, and so forth.

### Illustrative System

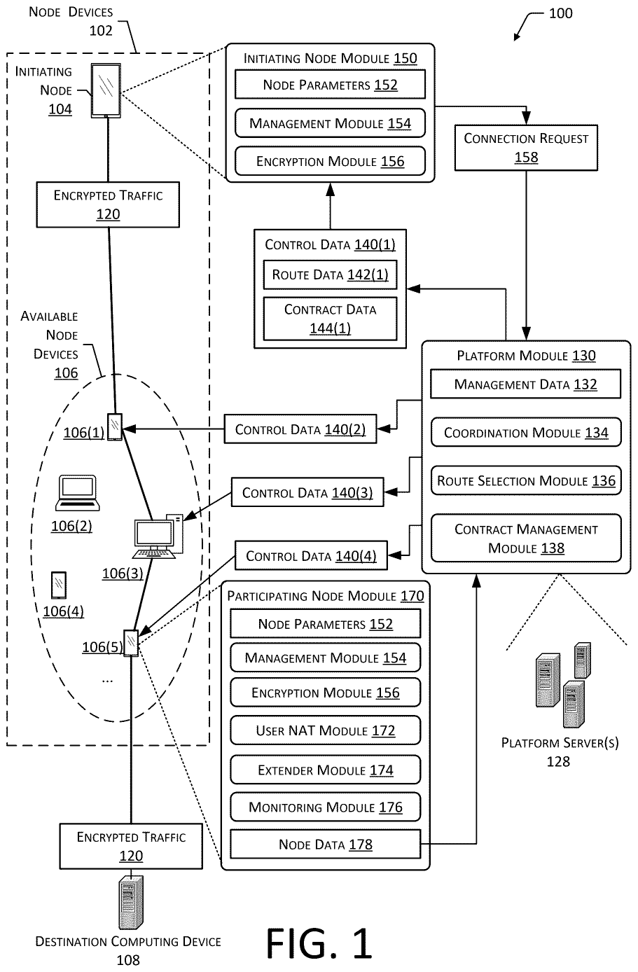

FIG. 1 illustrates at 100 a system comprising nodes and a platform to facilitate secure and private data transfer, according to some implementations.

A plurality of node devices (“node”) 102 are shown. Individual node devices 102 may comprise smartphones, laptop computers, desktop computers, servers, network enabled devices, or other computing devices that are connected via a communication interface to a network. Individual node devices 102 may perform particular functions corresponding to their mode of operation as described herein. For ease of illustration, and not necessarily as a limitation, nodes 102 may be described as initiating nodes 104 that initiate a secure communication, available nodes 106 that are available to secure communication, or participating nodes that are actively facilitating secure communication.

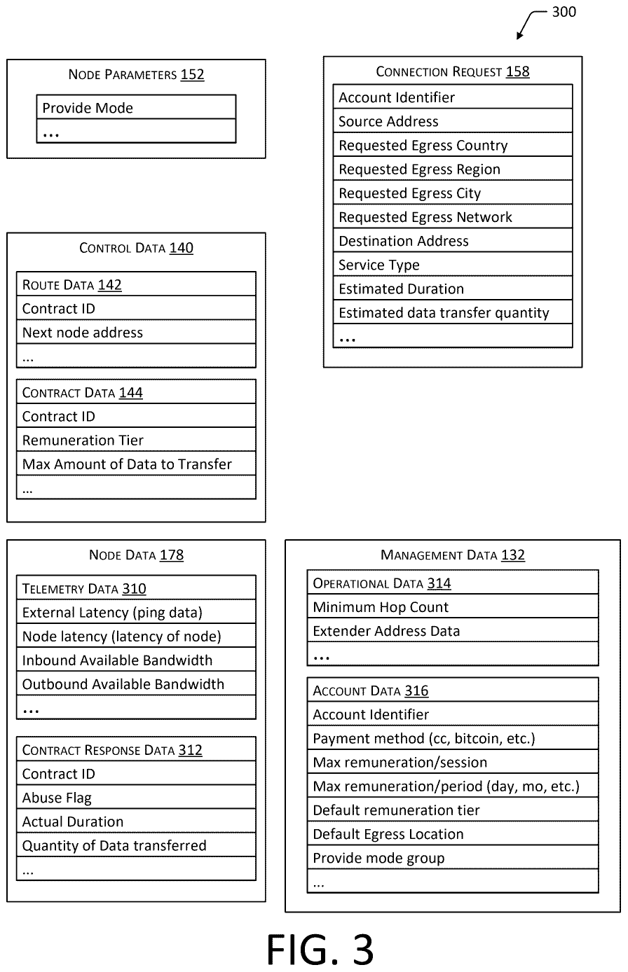

An initiating node 104 may execute an initiating node module 150. In some implementations the initiating node module 150 may execute within the user space of an operating system of the initiating node 104. The initiating node module 150 may store or otherwise access node parameters 152. The node parameters 152 may specify the mode of operation that the node 102 is to provide. The node parameters 152 are discussed in more detail below with regard to FIG. 3.

The initiating node module 150 may comprise a management module 154. The management module 154 may respond to requests for secure communication, operate other modules, and so forth. For example, an application (not shown) executing on the initiating node 104 may send to the management module 154 a request for a connection to a destination computing device 108. Responsive to this, the management module 154 may send a connection request 158 to a platform module 130. The connection request 158 may comprise information associated with establishment of a secure connection between the initiating node 104 and a destination address associated with a destination computing device 108. The connection request 158 is discussed in more detail below with regard to FIG. 3.

The initiating node module 150 may comprise an encryption module 156. The encryption module 156 may be used to encrypt data for transmission and decrypt data after reception. For example, the encryption module 156 may implement one or more of transport layer security (TLS), datagram transport layer security (DTLS), and so forth.

The platform module 130 is executed by one or more platform servers 128. The platform module 130 may store or otherwise access management data 132 during operation. The management data 132 is discussed in more detail below with regard to FIG. 3.

The platform module 130 may comprise a coordination module 134. The coordination module 134 may receive incoming connection requests 158 and process them accordingly. For example, the coordination module 134 may determine an account that is associated with the connection request 158, determine if the account has an available remuneration balance to pay for use of the system, and so forth.

The coordination module 134 may utilize a route selection module 136 to determine a route between the initiating node 104 and the destination computing device 108. The route specifies a set of participating nodes that will be transferring encrypted traffic 120 as part of a secure communication.

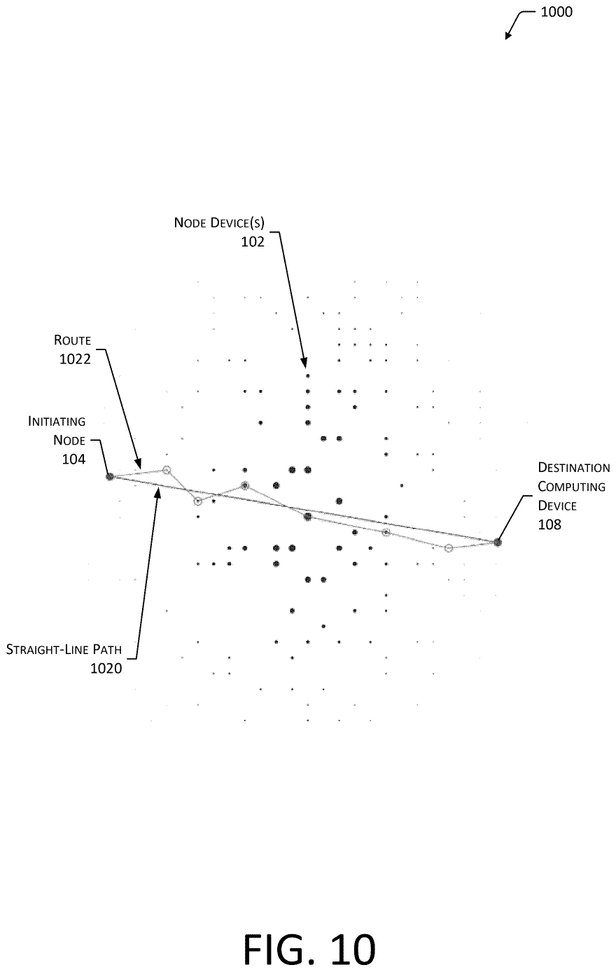

The route selection module 136 may utilize node data 178 indicative of latency to specified network addresses to determine a map of available node devices 106. Responsive to a connection request 158, this map may then be used to determine a multi-hop linear route using the available node devices 106. The multi-hop linear route may be determined using a multi-hop linear route algorithm that is discussed in more detail below with regard to FIG. 10 and in the Code Appendix. The route selection module 136 may be configured to select a route having a minimum number of hops. The route selection module 136 may also determine the route based on other information, such specified by the connection request 158 or as indicated by the management data 132. For example, the connection request 158 may specify an egress node that is within a particular geographic area, or the default for a specific account may specify an egress node within a specific network or network address range.

Based on the route, the route selection module 136 determines route data 142 that is associated with respective ones of the participating available nodes 106. The route data 142 may provide a next network address or “next hop” that encrypted traffic 120 is to be forwarded to.

A contract management module 138 may determine one or more contracts. With respect to the system, a contract comprises a set of conditions that are associated with providing the secure communication and associated remuneration. The one or more contracts may be embodied as contract data 140. The contract data 140 may include a contract identifier that is indicative of a particular contract. In one implementation, the same contract identifier may be used in the control data 140 for a secure communication session. In another implementation, each node may be provided with a different contact identifier.

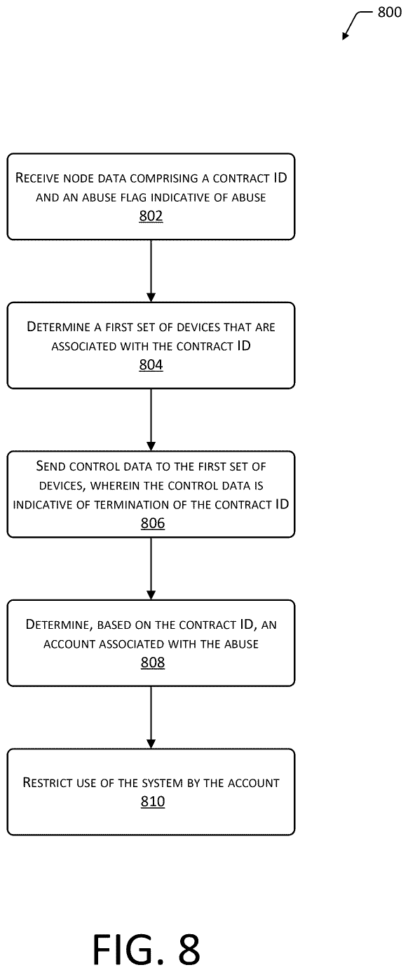

The contract management module 138 may perform various functions, such as mitigating abusive behavior, determining and settling remuneration, and so forth. A participating node 102 in a secure communication may determine abusive behavior. Responsive to this, the participating node 102 may discontinue the secure communication and send node data 178 indicative of this abusive behavior to the platform 130. In response to this, the platform 130 may send control data 140 to the other participating nodes 102 to close the contract and terminate the secure communication that is associated with the abusive behavior. This is discussed in more detail with regard to FIG. 8.

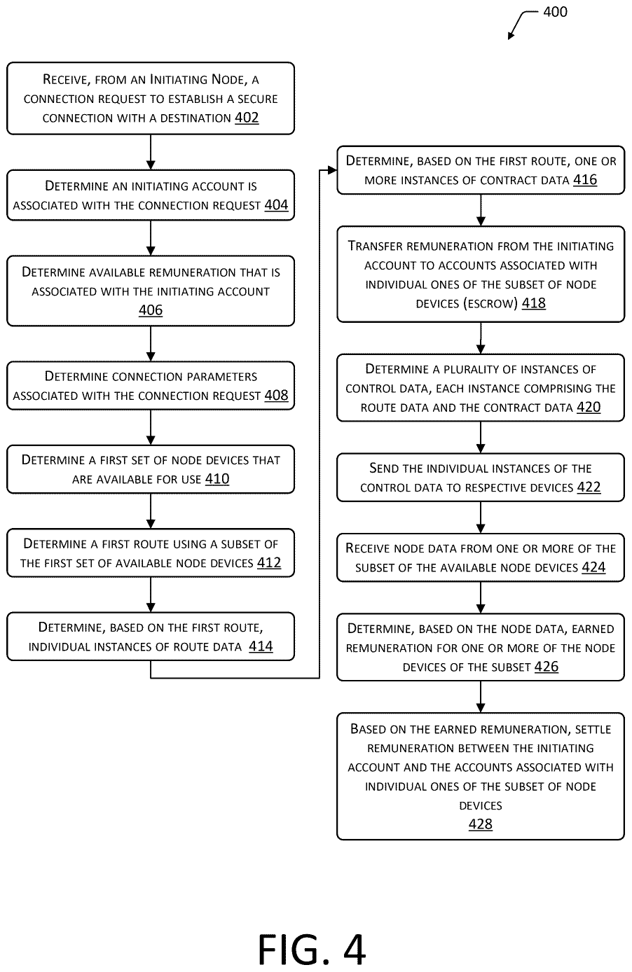

The contact management module 138 may determine if a contract has been closed, and if closed, if that contract is valid for remuneration. For example, the contact management module 138 may close the contract responsive to a message from the initiating node 104 that the secure communication is no longer needed. If the contract has been completed normally, remuneration may be provided to the participating nodes 102 who facilitated the secure communication. An escrow mechanism may be used to ensure remuneration to the participating nodes 102 before the secure communication begins. The processes of determining remuneration are discussed in more detail with regards to FIGS. 4, 6, and 7, as well as throughout the document.

Returning to the control data 140, individual instances of control data 140 are sent to respective ones of the available node devices 106 that will be participating in providing the secure communication to transfer encrypted traffic 120 from the initiating node 104 to the destination computing device 108.

A participating available node 106 may execute a participating node module 170. This may include the same or similar data or modules as described with regard to the initiating node module 150, and vice versa. In addition, the participating node module 170 may include one or more of a user network address translation (UNAT) module 172, an extender module 174, a monitoring module 176, and may determine node data 178.

The participating available node 106 receives the control data 140, and responsive to that, will relay encrypted traffic 120 that is associated with the control data 140 to a next hop. The next hop may be another participating available node 106 or the destination computing device 108. For example, responsive to the connection request 158, the platform module 130 has sent control data 140 to participating available node devices 106(1), (3), and (5). The initiating node 104 sends a first packet of encrypted traffic 120 to the participating available node 106(1). Node 106(1) acts as an ingress node and forwards this first packet to node 106(3). Node 106(3) forwards this first packet to node 106(5). Node 106(5), acting as the egress node, forwards this first packet to the destination address associated with the destination computing device 108. It is worth nothing that the encrypted traffic 120 does not pass through the platform servers 128.

The user NAT module 172 provides network address translation function that may be executed within the user space of the operating system of the node 102. Incoming encrypted traffic 120 may be exposed within the user space as data incoming on one or more raw sockets in the network stack provided by the operation system of the node 102. The user NAT module 172 may process the data provided by the one or more raw sockets and forward to user space sockets. The data sent to the user space sockets may then be processed to generate outbound packets for retransmission to a specified address. For example, the user NAT module 172 may generate packets and corresponding header information.

In one implementation, incoming encrypted traffic 120 is divided into tuples. A tuple may comprise one or more of source network address, source port, destination network address, destination port, and so forth. Each tuple may be assigned to a respective stream which eventually egresses from an egress node of the participating available node devices 106. The association of a tuple to a stream may be determined randomly. This further enhances security and privacy during operation. The user NAT module 172 or other module executing on the node 102 may apply local analysis and security rules to the encrypted traffic 120, such as blocking or limiting some destinations or server name indication (SNI) hosts.

During operation, the user NAT module 172 may receive the encrypted data 120 comprising an IP packet having associated data such as source network address, source port, destination network address, destination port, and forms a user network socket (such as a UDP socket or a TCP socket). The formation of the user network socket may utilize existing system network libraries. The tuple is associated with the network socket. For example, the tuple may be randomly assigned to a network socket. The IP packet is written to the user socket, and when the write completes, a response packet (e.g., ACK) is formed and sent back to the previous hop from which the incoming encrypted traffic 120 was received. This emulates a proper socket with congestion control, while being entirely implemented in user space.

In some implementations the user NAT module 172 may be used on one or more of the ingress node or egress nodes associated with providing secure communication. For example, node 106(1) that is communicating with the initiating node 104 may execute a first user NAT module 172(1) and node 106(5) that is communicating with the destination computing device 108 may execute a second user NAT module 172(2). In some implementations, the user NAT module 172 may be used to send encrypted traffic 120 to more than one egress node. The user NAT module 172 is discussed in more detail below and in more detail with regard to the Code Appendix, at least in the section “// apply userspacenat”.

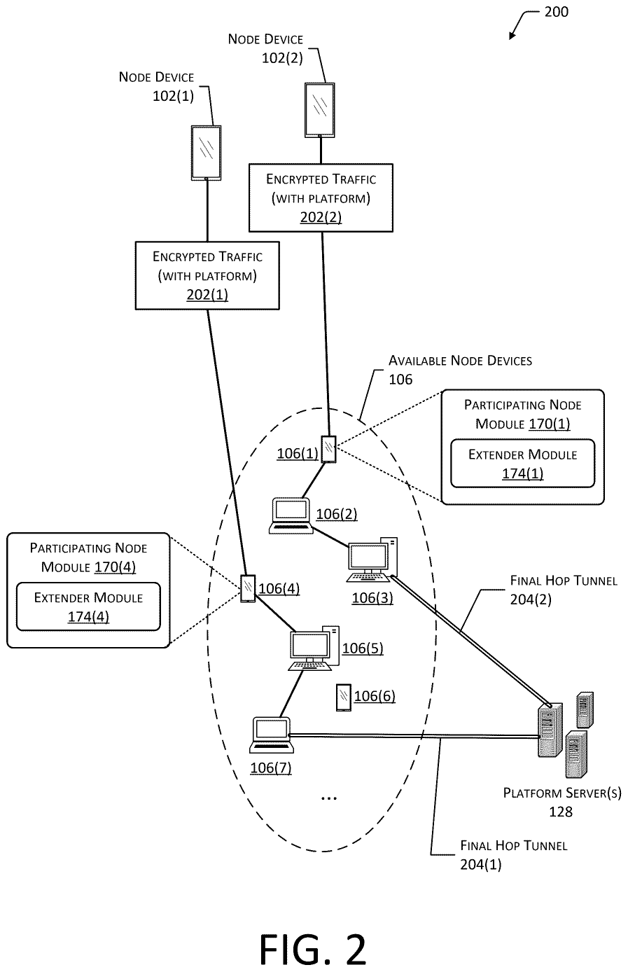

An extender module 174 allows the node 102 to relay communication to the platform module 130. For example, the extender module 174 may appear as another publicly available address for operation of the platform module 130. The extender module 174 is discussed in more detail below with regard to FIG. 2.

A monitoring module 176 may be used to determine node data 178. For example, the monitoring module 176 may determine ping times (latency) from the node 102 to one or more specified network addresses. Data indicative of these ping times may be sent to the platform module 130 for use by the route selection module 136. The node data 178 is discussed in more detail with regard to FIG. 3.

The monitoring module 176 may also be used to detect abusive behavior. The system may disallow some operations, such as transfer of unencrypted data, attempts to route traffic to a local or private subnet of the participating available node 106, attempts to use a self-signed certificate, and so forth. In the event one of these behaviors is detected, mitigating actions may be performed. For example, the monitoring module 176 may send node data 178 to the platform module 130 that is indicative of abusive behavior, the contract may be cancelled, communication service may be terminated, and so forth.

During operation of the system, the node devices 102 may continue to perform other operations that utilize the network to transfer data, separate from the use of the system to provide secure communication. For example, an application or other process executing on the initiating node 104 may use its the network connection to communicate with other servers. Meanwhile, applications or other processes executing on the various participating available nodes 106 may continue to operate, sending and receiving data from the respective nodes 106. As a result, the encrypted traffic 120 associated with the secure communication may be comingled with other data that inbound to, or outbound from, the nodes 102. This comingling further improves privacy and security by potentially obscuring the operation of the system to provide secure communication.

One or more of the modules described herein may be implemented using the Go language as originally developed by Google and promulgated at “go.dev”. Some examples of code corresponding to one or more modules is found within the Code Appendix and are expressed in the Go language.

Operation of the system and the various modules are discussed in more detail with regard to the following figures.

FIG. 2 illustrates at 200 use of an extender node to relay traffic to the platform, according to some implementations. Security and privacy of the platform may be enhanced by providing a wide variety of network addresses by which a node device 102 may communicate with the platform module 130. The extender module 174, when executed by a node device 102, provides this functionality.

The extender module 174 may be associated with an independent publicly accessible network address (such as an IPv4 or IPv6 address) and an independent hostname and TLS certificate. In some implementations these are “independent” in that they differ from a network address and hostname used by other processes executing on the node 102.

During operation, traffic to the extender module 174 may comprise HTTPS (hypertext transfer protocol secure) traffic inside of HTTPS traffic. The inner traffic, which starts with a TLS handshake, is forwarded verbatim to the platform servers 128. As a result of this a client such as a node 102 that is using an extender will resolve one or more of an independent IP address or hostname. Once resolved, communication may begin with the platform servers 128 with end-to-end TLS signed by the platform servers 128.

As shown in FIG. 2, there are two nodes 102 that are attempting to communicate with the platform module 130 executing on the platform servers 128. A first node 102(1) sends first encrypted traffic 202(1) to available node device 106(4) that is executing an extender module 174(4). The extender module 174(4) may then forward the first encrypted traffic 202(1) to node 106(5), which in turn forwards the first encrypted traffic 202(1) to node 106(7). In this illustration, an extender module 174(7) (not shown) of node 106(7) establishes an encrypted connection, shown as a final hop tunnel 204(1) with the platform server 128. For example, the encryption module 156(7) (not shown) establishes an encrypted final hop tunnel 204(1) with the platform servers 128. As a result of the final hop tunnel 204(1), the first encrypted traffic 202(1) is encrypted again before sending to the platform server 128.

In one implementation, the final hop tunnel 204 may utilize TLS. In other implementations, other protocols may be used. For example, the traversal using relays around NAT (TURN) protocol as specified in RFC 8656 may be used.

Also depicted is a second node 102(2) sends second encrypted traffic 202(2) to available node device 106(1) that is executing an extender module 174(1). The extender module 174(1) may then forward the second encrypted traffic 202(2) to node 106(2), which in turn forwards the second encrypted traffic 202(2) to node 106(3). In this illustration, an extender module 174(3) (not shown) of node 106(3) establishes an encrypted final hop tunnel 204(2) with the platform server 128. For example, the encryption module 156(3) (not shown) establishes an encrypted final hop tunnel 204(2) with the platform servers 128. As a result of the final hop tunnel 204(2), the second encrypted traffic 202(2) is encrypted again before sending to the platform server 128.

In this illustration, the routes used by the nodes 102(1) and 102(2) to communicate with the platform server 128 comprise a plurality of available nodes 106, resulting in a multi-hop route. In another implementation a single hop may be used. In some implementations the route selection module 136 may be used to determine the route between the available node devices 106 that are serving as extenders and the platform server 128.

Communication provided by the extender modules 174 may be unidirectional or bidirectional. Remuneration may also be provided, as described herein, to nodes 102 that provide extender functionality. For example, a node 102 may notify the coordination module 134 that it is available to provide extender functionality. Responsive to this, the coordination module 134 may send a request to the contract management module 138 to issue a contract and send corresponding contract data 144 to the node 102. Responsive to the contract data 144, the extender module 174 may proceed to relay traffic to the platform server 128.

FIG. 3 illustrates at 300 data associated with operation of the system, according to some implementations.

The node parameters 152 may include a “providemode” value that specifies the mode of operation of the node 102. In one implementation the mode of operation may specify who may utilize the node 102. For example, the mode of operation may specify “network”, “FF”, “public”, or “stream”. The network mode may specify only the owner of the device or group of devices may use the node 102. The FF mode may specify only a specified group of accounts, such as friends and family. The public mode may allow service to anyone who provides remuneration. The stream mode may limit to providing relay as an intermediate node on the route, and not an egress node. In other implementations the different modes of operation may specify operation of particular modules, such as the management module 154, user NAT module 172, extender module 174, and so forth. In other implementations other data may be included in the node parameters 152.

The connection request 158 may comprise information associated with establishment of a secure connection between the initiating node 104 and a destination address associated with a destination computing device 108. For example, the connection request 158 may comprise an account identifier, requested egress country, requested egress region, requested egress city, requested egress network, source address, destination address, service type, estimated duration, estimated data transfer quantity, requested egress location, and so forth. The account identifier may indicate an account used for remuneration. The source address may indicate the network address of the initiating node 104. In some implementations the source address may be determined based on data obtained by the platform module 130. For example, the source address may be obtained from a packet header of a packet containing the connection request 158. A requested egress country may indicate a desired destination country for an egress node. A requested egress region may indicate a desired destination region such as a particular geographic or geopolitical region for the egress node. A requested egress city may specify a desired city of the egress node. A requested egress network may specify a desired network associated with the egress node. A destination address indicates the network address of the destination computing device 108. The service type may indicate a type of service, such as regular, highest security, lowest cost, low latency, and so forth. The estimated duration may be indicative of an estimated interval of time or an end time of the secure communication. The estimated data transfer quantity may be indicative of the estimated amount of encrypted traffic 120 to be transferred. These or other parameters may be used to determine one or more egress nodes 102, each being the final hop for their respective streams which send the encrypted traffic 120 to the destination computing device 108 at the destination address. In other implementations other data may be included in the connection request 158.

The control data 140 may comprise the route data 142 and the contract data 144. The route data 142 may comprise one or more of a contract identifier (ID), next node address in the route, previous node address in the route, or other information. The contract data 144 may comprise one or more of the contract ID, remuneration tier, maximum (max) amount of data to transfer, or other information. The remuneration tier may comprise an indicia indicative of a particular remuneration range, remuneration methodology, and so forth. For example, the remuneration tier may specify a low, medium, or high pricing range, or specify remuneration methodology of pay based on time of the connection, pay based on data transferred, or a combined pay based on time and data transferred. The max amount of data to transfer may be indicative of a cap as to the quantity of encrypted traffic 120 that will be transferred during the specified contract. In other implementations the control data 140 may comprise other information.

In some implementations one or more portions of the control data 140 may be omitted. For example, the contract data 144 may be omitted in some implementations. The route data 142 may include the contract ID and the next node address. The participating node module 170 may then use the contract ID in the route data 142 for further operation.

The node data 178 comprises information associated with operation of a node 102. In some implementations the node data 178 may be determined by the monitoring module 176. The node data 178 may comprise telemetry data 310 or contract response data 312.

The telemetry data 310 comprises information associated with operation of the node 102 or the modules executing thereon. For example, the telemetry data 310 may comprise external latency data, node latency, inbound available bandwidth, outbound available bandwidth, or other information. The external latency data may comprise data indicative of response times for pings sent from the node 102 to one or more specified addresses. The node latency may be indicative of latency introduced by operation of the node 102. For example, the node latency may indicate the latency between receipt of an incoming packet to sending an outgoing packet. The inbound available bandwidth may be indicative of the unused data transfer capacity of the connection from the network to the node 102. The outbound available bandwidth may be indicative of the unused data transfer capacity of the connection from node 102 to the network. In other implementations the telemetry data 310 may comprise other information.

The contract response data 312 comprises information associated with operation of the node 102 with respect to the contract. For example, the contract response data 312 may comprise the contract ID, an abuse flag, actual duration of the secure communication, quantity of data transferred during the secure communication, and so forth. As described herein, the abuse flag may be used to designate if abusive behavior has been detected. In other implementations the contract response data 312 may comprise other information.

In some implementations, contract response data 312 may be provided by specified nodes 102, such as one or more of the initiating node 104, the egress node of the participating available node devices 106, and so forth.

The management data 132 may comprise operational data 314 and account data 316. The operational data 314 may comprise information associated with operation of the platform module 130 to provide secure communication. The operational data 314 may comprise one or more of a minimum hop count, extender address data, or other data. The minimum hop count specifies a minimum number of nodes that each route is required to have. The extender address data may indicate the network addresses of the nodes 102 that are providing extender services using the extender module 174. In other implementations the operational data 314 may comprise other information.

The account data 316 may comprise information about the accounts that are associated with the users of the system. The account data 316 may comprise one or more of an account identifier, payment method, maximum (max) remuneration per session, max remuneration per period, default remuneration tier, default egress location, provide mode group, or other data. The account identifier indicates the particular account. The payment method may specify a bank account number, credit card account number, cryptocurrency value, and so forth. The max remuneration per session may specify a maximum amount that the account holder is willing to pay for a single session or contract. The max remuneration per period may specify a maximum amount that the account holder is willing to pay for contracts within a specified period of time, such as an hour, day, month, and so forth. The default remuneration tier may specify the remuneration tier, as described above, that the account holder has specified to use by default. The default egress location may specify one or more of a geographic region, network address, network provider, or other parameter that may be used to select a particular node 102 for use as an egress point. The provide mode group may be used to specify an affiliation or grouping for use in conjunction with the node parameters 152. For example, the provide mode group may specify the name of a common entity or group of users who are affiliated and agree to participate.

In other implementations, other data not depicted here may be used during operation of the system.

FIG. 4 depicts a flow diagram 400 of a process to provide secure and private data transfer, according to some implementations. The process may be implemented by one or more computing devices of the system 100, such as one or more nodes 102, platform servers 128, and so forth.

At 402 a connection request 158 to establish a secure connection with a destination indicated by destination data is received from an initiating node 104. For example, the connection request 158 may be sent from the initiating node 104 to the platform servers 128 using the network. The connection request 158 may comprise one or more of a destination network address, country, region, city, network, minimum number of hops, and so forth. In another example, the connection request 158 may be sent from the initiating node 104 to the platform servers 128 via one or more extender modules 174.

At 404 an initiating account 620 associated with the connection request 158 is determined. For example, the connection request 158 may include an account identifier. The account identifier may be used to retrieve from a data store the initiating account 620.

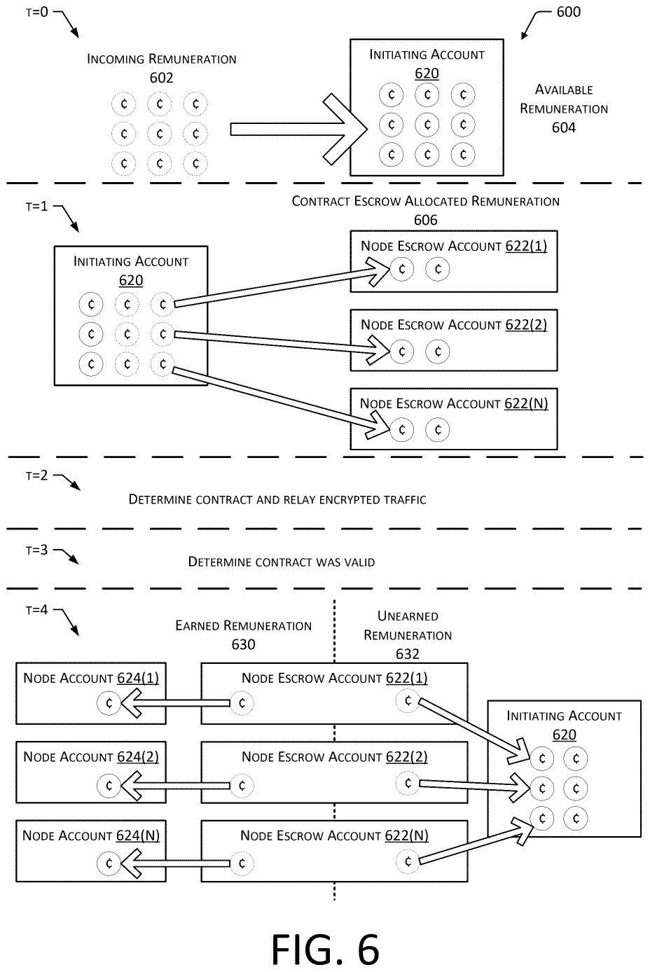

At 406 available remuneration is determined that is associated with the initiating account. For example, the current balance of available remuneration in the initiating account 620 (see FIG. 6) may be determined. In some implementations a determination may be made as to whether there is sufficient available remuneration for the process to proceed. For example, if there is a zero balance of available remuneration, a user interface may be presented on the initiating node 104 to add more remuneration to the initiating account 620.

At 408 the initiating account 620 is associated with the connection request 158. For example, for subsequent operations, remuneration associated with the connection request 158 is deemed to be provided by the initiating account 620.

At 410 one or more connection parameters are determined that are associated with the connection request 158. The connection parameters may be indicative of one or more of: estimated duration of the secure connection, estimated data transfer quantity, requested egress location of the secure connection, priority of the secure connection, remuneration tier, or other information.

At 412 a first set of node devices 106 are determined that are available for use. For example, the first set of node device 106 may comprise nodes 102 that have sent node data 178 such as telemetry data 310 to the platform module 130 within some threshold time, such as the last ten minutes, and are in a provide mode that is permitted to satisfy the connection request 158. For example, a node 102 that has sent telemetry data 310 within the last ten minutes and is in the “public” mode for the node 102 may be deemed available to provide service for the connection request 158.

At 414 a first route is determined using a subset of the first set of node devices 106. This determination may be based on the connection request 158. For example, a source address associated with the connection request 158 and destination data in the connection request 158 may be used as input to the route selection module 136. The route selection module 136 may use the input to determine the first route comprising a plurality of participating available node devices 106. In one implementation the route selection module 136 may use a multi-hop linear path (MHLP) algorithm. A first set of latency data acquired by the first set of node devices 106 is determined. For example, the telemetry data 310 is received from nodes 102. Based on the first set of latency data, a first map is determined. For example, the first map may comprise two-dimensional representation of the first set of latency data as processed using principal component analysis (PCA). The MHLP algorithm utilizes the first map and a bisection algorithm to determine the first route from the source address to the destination data. In some implementations, the MHLP algorithm determines a route that provides minimal total latency. In other implementations, the route selection module 136 may use other algorithms for route determination. For example, the route selection module 136 may use an algorithm that determines a route while excluding specified networks, geographic areas, and so forth.

During operation the route selection module 136 may use one or more parameters to determine the route. For example, if the connection request 158 specifies particular egress parameters such as geographic location, network address range, network provider, and so forth, the route may be determined based on this information. In another example, one or more of the connection parameters may be used by the route selection module 136 to determine the route.

In some implementations, the first route or information based thereon, may be returned to the initiating node 104. The initiating node 104 may then confirm the use of the first route, or request generation of another route. If another route is requested, the route selection module 136 may proceed to generate a second route and provide information based thereon to the initiating node 104 for confirmation.

At 416, based on the first route, individual instances of route data 142 are determined. For example, each instance of route data 142 may comprise the next node address. In this way, none of the individual available nodes 106 that participate in the secure communication know the complete route from source address to destination data.

At 418, based on the first route, one or more instances of contract data 144 are determined. As described above, in one implementation a single contract may be used for all participating nodes 102. In another implementation each participating node may be provided with a separate contract. In some implementations the contract may be based at least in part on one or more of the connection parameters. For example, a contract for a secure connection that has a higher priority may be associated with a more expensive remuneration tier.

In one implementation, at 420 remuneration is transferred from the initiating account 620 to accounts associated with individual ones of the of the subset of node devices. For example, contract escrow allocated remuneration 606 may be transferred from the initiating account 620 to individual node escrow accounts 622. In other implementations other processes may be used. For example, remuneration may be reserved within the initiating account 620 until completion of a contract and settlement at 430.

At 422 a plurality of instances of control data 140 are determined. Each instance of control data 140 comprises the route data 142 and the contract data 144 associated with a respective one of the subset of the first set of node devices 106.

At 424 the individual instances of the plurality of instances of control data 140 are sent to the respective ones of the subset of the first set of node devices 106.

In some implementations, at 426 node data 178 is received from one or more nodes of the subset of the node devices 106. For example, the participating available node devices 106 that facilitated the secure communication and transferred encrypted traffic 120 may send to the platform module 130 contract response data 312.

At 428 earned remuneration is determined for one or more node devices of the subset of the first set of node devices 106. For example, the contract response data 312 may indicate the quantity of data transferred, actual duration, or other information. Based on this, the contract management module 138 may determine earned remuneration 630 for each of the participating devices. Determination of remuneration is discussed in more detail with regard to later figures.

At 430 remuneration between the initiating account and node accounts associated with individual ones of the subset of the first set of node devices 106 is settled. For example, respective amounts of remuneration may be transferred from node escrow accounts 622 to node accounts 624.

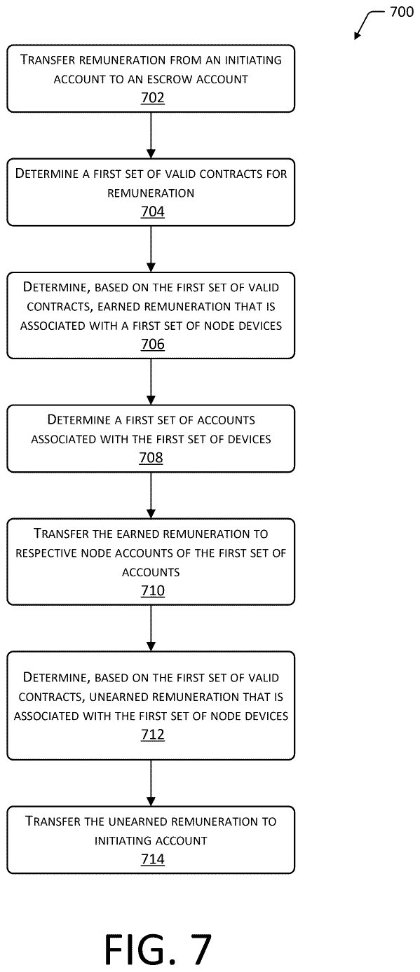

As described below in more detail with regard to at least FIGS. 7-9, detection of abusive behavior may result in other operations being performed.

In some implementations one or more of the operations described above may be omitted or the order in which they are performed may be changed. For example, operation 420 may be omitted.

Sending and receiving the data described with regard to the flow diagrams and otherwise herein may be performed using the communication interface(s) of the respective devices.

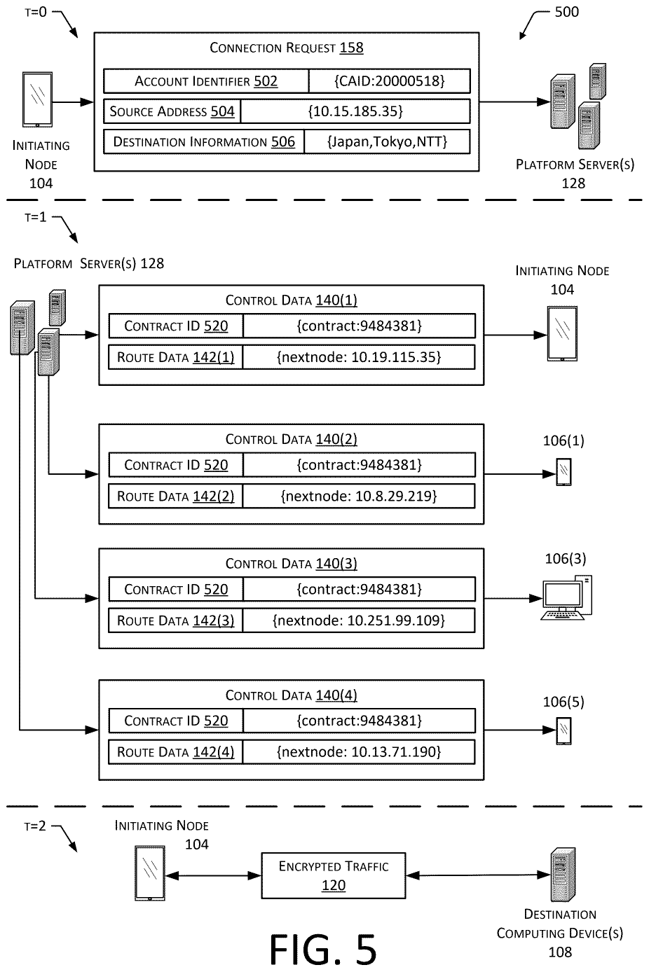

FIG. 5 illustrates at 500 operation of the system to establish secure communication, according to some implementations. The operations described may be implemented by one or more computing devices of the system, such as the platform servers 128.

At t=0 the client node 104 sends the connection request 158 to the platform server(s) 128. In this illustration, the connection request 158 includes an account identifier 502, source address 504, and destination information 506.

At t=1 the platform server 128 has determined the route data 142 and contract data 144 based at least in part on the connection request 158. Responsive to this, the platform server 128 sends the control data 140(1)-(4) to the respective nodes. Control data 140(1) is sent to the initiating node 104, control data 140(2) is sent to node 106(1), control data 140(3) is sent to node 106(3), and control data 140(4) is sent to node 106(5). In this illustration, node 106(1) is the ingress node and node 106(5) is the egress node.

As described above, each instance of the route data 142 differs from the others. As described above, in some implementations the contract data, indicated by the contract ID 520, may be the same across all participating nodes 102 (as shown here), or may differ.

At t=2 the initiating node 104 and the destination computing device(s) 108 exchange encrypted traffic 120. The relay of encrypted traffic 120, as enabled by the control data 140, may be referred to as a “stream”. As mentioned above, it is important to note that the platform server(s) 128 do not participate in relaying the encrypted traffic 120. As also mentioned above, the participating nodes that relay the traffic are not provided with the information that would be needed to decrypt the encrypted traffic 120. As a result, the participating nodes have no knowledge of the payload within the encrypted traffic 120.

During operation the participating node module 170 may manage the transfer of encrypted traffic 120. For example, encrypted data 120 may be temporarily buffered when received before being transmitted to the next hop.

In some implementations, transfer of encrypted traffic 120 between nodes 102 may be managed using a congestion window technique similar to QUIC as promulgated by the Internet Engineering Task Force (IETF) RFCS 9002 et al. The transfer between nodes 102 may be managed to reduce the impact of any one bad hop in a multi-hop route, by not retransmitting the data across the entire route. For example, a failed packet may be resent by the immediately preceding node, and not by the initiating node 104.

FIG. 6 illustrates at 600 providing remuneration during operation of the system, according to some implementations. The operations described may be implemented by one or more computing devices of the system 100, such as the platform servers 128.

At t=0 incoming remuneration 602 is added to an initiating account 620 to provide available remuneration 604. For example, a user may initiate a wire transfer, automated clearing house (ACH) transfer, cryptocurrency transfer, points transfer, and so forth to add remuneration to pay for use of the system. In this illustration, nine units of value have been added to the initiating account 620, so the available remuneration 604 is nine units.

At t=1, based on the connection request 158, some remuneration is transferred from the initiating account 620 to respective node escrow accounts 622. Each participating available node 106 may have an associated node escrow account 622. For example, with respect to the route depicted in FIG. 1, node 106(1) may be associated with node escrow account 622(1), node 106(2) may be associated with node escrow account 622(2), node 106(3) may be associated with node escrow account 622(2), and node 106(5) may be associated with node escrow account 622(3). In this illustration, each node 102 that receives remuneration is allocated two units.

In some implementations, the contract escrow allocated remuneration 606 may comprise at least a minimum escrow amount. This minimum escrow amount may be set to discourage abusive behavior. For example, a determination of abusive behavior by the initiating node 104 may result in forfeiture by the initiating account 620 of the remuneration placed in escrow. In an implementation such as shown here, the forfeited remuneration may be distributed to the associated node accounts 624 as discussed below. In another implementation, unearned remuneration 632 that has been forfeited may be distributed to another account, such as a platform forfeiture account.

In some implementations the node escrow accounts 622 are limited to remuneration transfers to and from other escrow accounts or user accounts such as the initiating account 620. In comparison, user accounts such as the initiating account 620 and the node accounts 624 may permit remuneration transfers to and from external sources. For example, a user may be permitted to transfer remuneration to their node account 624 but is not permitted to transfer remuneration directly to the node escrow account 622.

At t=2 the contract(s) are determined and the encrypted traffic 120 is relayed by the participating available nodes 106.

At t=3 the contract(s) are determined to be valid. Determination of contract validity is discussed in more detail below with regard to FIG. 7.

At t=4 earned remuneration 630 is transferred to respective node accounts 624 associated with the node escrow accounts 622, and unearned remuneration 632 is returned to the initiating account 620. Continuing the example above, the actual secure communication consumed only one unit of remuneration for each node 106. As a result, a single unit of earned remuneration 630 is determined for each node 106, and is transferred from the respective node escrow account 622 to the node account 624. Likewise, the remaining single unit of unearned remuneration 632 is returned to the initiating account 620.

By using this process, remuneration to the participating nodes 106 is assured before secure communication begins. As described earlier, in other implementations other variations of escrow may be used.

Because the nodes 102 may operate in different modes, the balance of remuneration available may change over time. For example, remuneration may be transferred out as a node 102 associated with an account uses the system for secure communication and remuneration may be transferred in as the node 102 provides secure communication for others.

FIG. 7 depicts at 700 a flow diagram of a process to provide remuneration, according to some implementations. The process may be implemented by one or more computing devices of the system 100, such as one or more nodes 102, platform servers 128, and so forth.

At 702 remuneration is transferred from an initiating account 620 to one or more node escrow accounts 622. This transfer may occur before initiating the secure connection. For example, based on a connection request 158, a preset remuneration amount, or an amount that is based on the route data 142 and connection parameters may be determined.

At 704 a first set of valid contracts are determined for remuneration. For example, a valid contract may comprise a contract that has been closed without dispute. A contract may be closed based on one or more of expiration of a time limit, upon transferring a preset maximum amount of data, responsive to a message to close from the initiating node 104, determination of abusive behavior, and do so forth.

Invalid contracts may be processed to resolve any outstanding dispute. In some implementations, while a dispute is outstanding, all parties associated with those disputed contracts may be prevented from creating further contracts. The dispute may be resolved using one or more mechanisms. A first mechanism may include intervention by a human operator. A second mechanism may include analyzing usage of the system by the contract participants. For example, a statistical analysis may be used to determine if one party to the contract has connection requests 158, telemetry data 310, contract response data 312, or other information that deviates from an expected value by greater than a threshold amount. The expected value may be associated with a specific account identifier, category of account, and so forth. A third mechanism may include requesting one of the parties to voluntarily settle the dispute by forfeiture of any remuneration due to their account.

At 706 earned remuneration 630 is determined that is associated with the subset of the first set of node devices 106 that participating in providing the secure communication. Earned remuneration 630 may be determined based on the node data 178. For example, earned remuneration 630 may use actual duration and quantity of data transferred to calculate the earned remuneration 630. In another example, determination of abusive behavior by an initiating device 104 may result in the entire amount of remuneration in the node escrow accounts 622 being deemed to have been earned remuneration 630. In this example, the user associate with the abusive behavior forfeits the entire amount held in the node escrow accounts 620 that are associated with the contract. This provides significant negative feedback to dissuade abusive behavior while using the system.

At 708 a first set of accounts are determined that are associated with the subset of the first set of node devices 106. For example, the node accounts 624 are determined that are associated with the participating available nodes 106.

At 710 the earned remuneration is transferred to respective ones of the first set of accounts. For example, the earned remuneration 630 is transferred from the respective node escrow accounts 622 to the respective node accounts 624.

At 712 unearned remuneration 632 is determined that is associated with the subset of the first set of node devices 106.

At 714 the earned remuneration 632 is transferred to the initiating account 620, completing the settlement of remuneration for the contract.

In some implementations, each contract may be settled individually, while in other implementations groups of contracts may be processed in a batch.

FIG. 8 depicts at 800 a flow diagram of a process to cancel communication service associated with detected abusive behavior, according to some implementations. The process may be implemented by one or more computing devices of the system 100, such as one or more nodes 102, platform servers 128, and so forth.

At 802 node data 178 is received from one or more of a subset of the first set of node devices 106 that are participating in providing communication service. The node data 178 is indicative of abuse associated with a contract identifier associated with the secure connection. For example, the node data 178 may comprise a message with an “abuse” flag set to “true”.

The system may disallow some operations as abusive behaviors, such as transfer of unencrypted data, attempts to route traffic to a local or private subnet of the participating available node 106, attempts to use a self-signed certificate, and so forth. In the event one of these behaviors is detected, the node data 178 comprising the abuse flag of “true” may be generated and sent to other participating devices, such as other devices within the route of the secure communication, the platform server(s) 128, or both. For example, the monitoring module 176 of node 106(3) determines that the secure connection is attempting to connect to a private subnet of that node 106(3). The node 106(3) sends node data 178 to the platform module 130 that is indicative of abusive behavior.

At 804 the subset of the first set of node devices 106 is determined that are associated with the contract identifier. For example, the contract identifier may be used to retrieve the participating available nodes 106 that are providing secure communication for the contract indicated by the contract identifier.

At 806 additional control data 140 is sent to the subset of the first set of node devices 106. The additional control data 140 is indicative of termination of the secure connection associated with the contract identifier. Responsive to the additional control data 140, the respective nodes in the subset may terminate communication services for that contract.

In some implementations, additional mitigating actions responsive to the abusive behavior may be performed, such as described next.

At 808, based on the contract identifier, an account associated with the abusive behavior is determined. For example, the contract identifier may be used to retrieve the account identifier.

At 810 use of the system by the account may be restricted. For example, the account may be issued a warning, suspended, and so forth. In some implementations, different thresholds for action may be specified. For example, more than one instance of abusive behavior in a 24 hour period may result in account suspension.

In some implementations one or more of the operations described above may be omitted or the order in which they are performed may be changed.

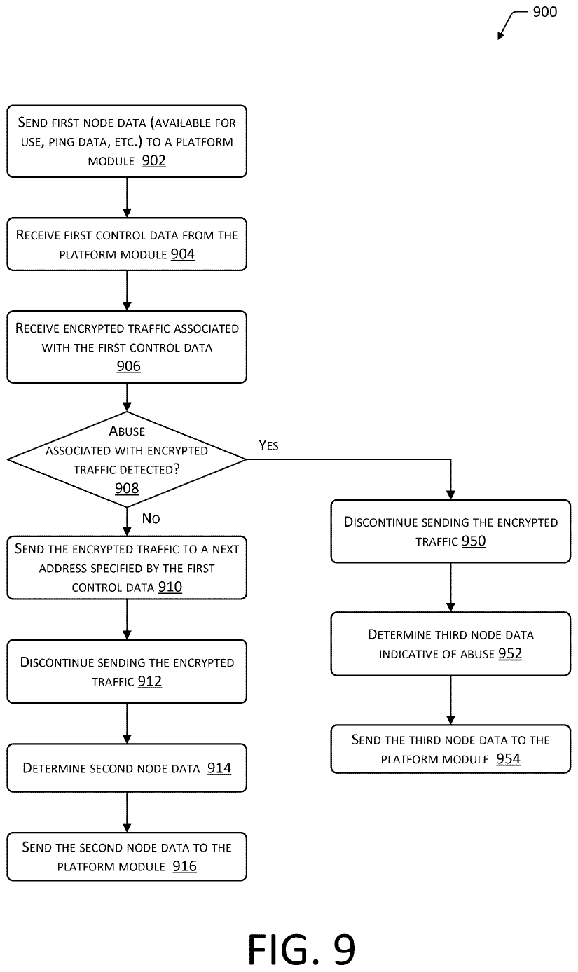

FIG. 9 depicts at 900 a flow diagram of a process for a node to relay encrypted traffic, according to some implementations. The process may be implemented by one or more computing devices of the system 100, such as one or more nodes 102, platform servers 128, and so forth.

At 902 the first node 102 sends first node data 178 to the platform module 130. The first node data 178 may comprise telemetry data 310. As described, the route selection module 136 may use the telemetry data 310.

At 904 first control data 140 is received from the platform module 130. As described, the first control data 140 may comprise one or more of route data 142 or contract data 144.

At 906 encrypted traffic 120 is received that is associated with the first control data 140.

At 908 determination is made as to whether abusive behavior associated with the encrypted traffic 120 is determined. As described above, abusive behavior may comprise transfer of unencrypted data, attempts to route traffic to a local or private subnet of the node 102, use of a self-signed certificate, and so forth. If yes, the process may proceed to 950. If no, the process may proceed to 910.

At 950 the node 102 discontinues sending the encrypted traffic 120.

At 952 third node data 178 is determined that is indicative of abuse. For example, the third node data 178 may comprise contract response data 312 with an abuse flag set to “true”.

At 954 the third node data is sent to the platform module 130. As described earlier with regard to FIG. 8, responsive to this the platform module 130 may cancel the associated contracts and terminate the secure communication at the other participating available nodes 106.

As described above, in the event abusive behavior is determined, the initiating account 620 may forfeit contract escrow allocated remuneration 606. For example, such forfeiture may be implemented by transferring unearned remuneration 632 to another account, such as a node account 624, account associated with the system 100, and so forth.

In some implementations, the destination of the forfeited remuneration may be determined based on the party that performed the abusive behavior. For example, if the abusive behavior is attributed to the initiating node 104, the initiating account 620 may forgo all associated remuneration in the contract escrow allocated remuneration 606. In another example, if the abusive behavior is attributed to a participating node of the available node devices 106, that particular node may forfeit the amount in its respective node escrow account 622. At 910 the encrypted traffic 120 is sent to a next address specified by the first control data 140. For example, the encrypted traffic 120 is relayed to the next hop in the route.

At 912 the node 102 discontinues sending the encrypted traffic 120. For example, the initiating node 104 may cease sending the encrypted traffic 120, the secure communication may have reached a preset maximum amount of data permitted by the contract which as a result has been closed, the secure communication may have reached a preset time limit and is now expired, a message to close the contract may have been received, and so forth.

Closure of the contract upon reaching a preset maximum amount of data allows the system to use the escrow mechanisms described herein while avoiding encumbering relatively large amounts of remuneration in escrow. A new contract, and associated contract data 144 may be subsequently determined. In some implementations, a new contract as expressed in contract data 144 may be determined before an existing contract reaches the preset maximum amount of data. In such an implementation, the platform module 130 may coordinate a transition from the existing contract data 144 to the new contract data 144 while maintaining secure communication and without disrupting transfer of encrypted traffic 120.

In some implementations, at 914 second node data 178 may be determined. For example, the second node data 178 may comprise contract response data 312 that provides information about the secure connection.

At 916 the second node data 178 is sent to the platform module 130. As described earlier, the platform module 130 may use the second node data 178 to determine settlement of remuneration.

FIG. 10 depicts a map 1000 used for route selection from available node devices 106, according to one implementation. The process may be implemented by one or more computing devices of the system 100, such as one or more nodes 102, platform servers 128, and so forth. In some implementations the process may be implemented by the route selection module 136.

Telemetry data 310 may be received from nodes 102. For example, one or more of the available node devices 106 or the initiating node 104 may send telemetry data 310 to the platform module 130. The telemetry data 310 may comprise data indicative of latency between the reporting node 102 and other devices connected to the network. Based on this telemetry data 310, a first set of latency data may be acquired.

The first set of latency data may be processed to determine a first map 1000. The first set of latency data may comprise an N-dimensional set of data, where each dimension is indicative of latency to a specified address. This map 1000 may comprise a two-dimensional representation of the nodes 102 based on the N-dimensional latency data. In one implementation, a principal component analysis (PCA) algorithm may be used to process the first set of latency data and determine a two-dimensional projection, or “map”, of that data. This map provides a dimensionally-reduced representation of the nodes 102 relative to one another with respect to latency.

In this illustration, each circle represents a node device 102 that has been deemed available for use to fulfill a connection request 158. Nodes 102 with similar latency measurements are near each other in the map 1000.

During operation, the route selection module 136 may use this map 1000 to determine the route from the source address of the initiating node 104 to the destination address of the destination computing device 108 or a specified egress node 102. The route selection module 136 may determine a route that includes a specified minimum number of hops, while minimizing overall latency. In one implementation, the route selection module 136 may use a multi-hop linear path (MHLP) algorithm. The MHLP algorithm utilizes the first map 1000 and a bisection algorithm to determine the first route from the source address to the destination address or specified egress node address.

To find H hops between two clients, a bisection algorithm is used in which a mid-point is chosen with probability weight as follows:

PROJ(distance(a),distance(b))/MIN(PROJ(distance(a),distance(b)) EQUATION 1
where:
the PROJ function accepts as input vectors having at least two dimensions and returns a single value;
a is a first node 102,
b is a second node 102, and
p is a factor that controls how much weight is given to deviation from the straight line.

In other implementations other projections may be used.

Note that as p increases, the likelihood that the chosen midpoint will be the true minimum latency route increases. The probability weights may be used to distribute traffic between comparable nodes 102. This may be used to avoid saturating a single node 102 with operations associated with the platform. The route is then determined based on the mid-points that have been ordered with the lowest latency metric listed first, and longest latency metric listed last.

Additional details with regard to the MHLP algorithm are found in the Code Appendix at “#Multi Hop Linear Path”.

A straight-line path 1020, with respect to the map 1000, between the source address of the initiating node 104 and the destination address of the destination computing device 108 is depicted. In other implementations, instead of the destination address, an egress node 102 that satisfies the connection request 158 may be used. The route 1020 determined by the bisection algorithm is also depicted.

A single route 1022 is depicted in FIG. 10 and described above for ease of illustration and discussion, and not necessarily as a limitation. In some implementations a plurality of routes may be determined responsive to a single connection request 156. The plurality of routes may then be used to relay encrypted traffic 120 associated with a single secure communication session. For example, encrypted traffic 120 may be divided across many different routes while providing secure communication. This may be used to minimize the resource-utilization of a given participating node 106, avoid all traffic from traversing a single intermediate node 102 within a route, and so forth.

In some implementations, during secure communication, the route 1022 may be changed. For example, the initiating node 104 may send to the platform module 130 a command to “shuffle” or change the route 1022 being used. Responsive to this, the route selection module 136 may send updated route data 142 indicative of a different route 1022 to the participating nodes 106. The participating nodes 106 may then use the updated route data 142 to implement the different route 1022.

In other implementations, other techniques may be used to determine the route 1022.

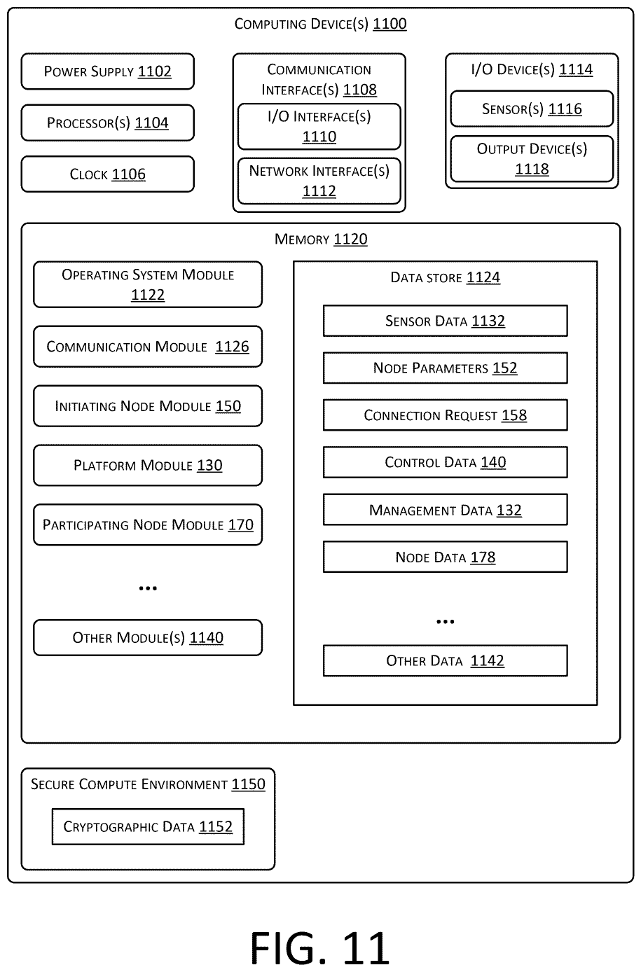

FIG. 11 is a block diagram of a computing device 1100 of the system 100, according to some implementations.

The computing device 1100 comprise a smartphone, tablet, laptop computer, desktop computer, server, and so forth. With regard to servers and other similar devices, such a computing device 1100 does not require end-user knowledge of the physical location and configuration of the system that delivers the services. Common expressions associated with the computing device 1100 may include “embedded system”, “on-demand computing”, “software as a service (SaaS)”, “platform computing”, “network-accessible platform”, “cloud services”, “data centers”, and so forth. Services provided by the computing device 1100 may be distributed across one or more physical or virtual devices.

One or more power supplies 1102 may be configured to provide electrical power suitable for operating the components in the computing device 1100. The one or more power supplies 1102 may comprise batteries, capacitors, fuel cells, photovoltaic cells, wireless power receivers, conductive couplings suitable for attachment to a power source such as provided by an electric utility, and so forth. The computing device 1100 may include one or more hardware processors 1104 (processors) configured to execute one or more stored instructions. The processors 1104 may comprise one or more cores. One or more clocks 1106 may provide information indicative of date, time, ticks, and so forth. For example, the processor 1104 may use data from the clock 1106 to associate a particular interaction with a particular point in time.

The computing device 1100 may include one or more communication interfaces 1108 such as input/output (I/O) interfaces 1110, network interfaces 1112, and so forth. The communication interfaces 1108 enable the computing device 1100, or components thereof, to communicate with other devices or components. The communication interfaces 1108 may include one or more I/O interfaces 1110. The I/O interfaces 1110 may comprise Inter-Integrated Circuit (I2C), Serial Peripheral Interface bus (SPI), Universal Serial Bus (USB) as promulgated by the USB Implementers Forum, RS-232, and so forth.

The I/O interface(s) 1110 may couple to one or more I/O devices 1114. The 1/O devices 1114 may include input devices such as one or more of a sensor 1116, keyboard, mouse, scanner, and so forth. The I/O devices 1114 may also include output devices 1118 such as one or more of a display device, printer, audio speakers, and so forth. In some embodiments, the 1/O devices 1114 may be physically incorporated with the computing device 1100 or may be externally placed. The sensors 1116 may comprise cameras, microphones, and so forth.

The network interfaces 1112 may be configured to provide communications between the computing device 1100 and other devices, such as routers, access points, and so forth. The network interfaces 1112 may include devices configured to couple to personal area networks (PANs), local area networks (LANs), wireless local area networks (WLANS), wide area networks (WANs), and so forth. The network interfaces 1112 may include devices compatible with Ethernet, Wi-Fi, LTE, 5G, 6G, and so forth.

The computing device 1100 may also include one or more buses or other internal communications hardware or software that allow for the transfer of data between the various modules and components of the computing device 1100.

As shown in FIG. 11, the computing device 1100 includes one or more memories 1120. The memory 1120 may comprise one or more non-transitory computer-readable storage media (CRSM). The CRSM may be any one or more of an electronic storage medium, a magnetic storage medium, an optical storage medium, a quantum storage medium, a mechanical computer storage medium, and so forth. The memory 1120 provides storage of computer-readable instructions, data structures, program modules, and other data for the operation of the computing device 1100. Some functional modules are shown stored in the memory 1120, although the same functionality may alternatively be implemented in hardware, firmware, or as a system on a chip (SoC).

The memory 1120 may include at least one operating system (OS) module 1122. The OS module 1122 is configured to manage hardware resource devices such as the I/O interfaces 1110, the I/O devices 1114, the communication interfaces 1108, and provide various services to applications or modules executing on the processors 1104. The OS module 1122 may implement a variant of the FreeBSD operating system as promulgated by the FreeBSD Project; other UNIX or UNIX-like variants; a variation of the Linux operating system; the Windows operating system from Microsoft Corporation of Redmond, Washington, USA; and so forth.

Also stored in the memory 1120 may be a data store 1124 and one or more of the following modules. These modules may be executed as foreground applications, background tasks, daemons, and so forth. The data store 1124 may use a flat file, database, linked list, tree, executable code, script, or other data structure to store information. In some implementations, the data store 1124 or a portion of the data store 1124 may be distributed across one or more other devices including other computing devices 106, network attached storage devices, and so forth.

A communication module 1126 may be configured to establish communications between the computing device 1100 and other computing devices 1100 such as node devices 102. The communications may be authenticated, encrypted, and so forth.

The memory 110 may store one or more of the initiating node module 150, platform module 130, participating node module 170, or elements thereof, depending on the device and its role in the system.

The data store 1124 may be used to store various information. For example, the data store 1124 may be used to sensor data 1132, node parameters 152, connection requests 158, control data 140, management data 132, node data 178, and so forth. Some data may be deleted once no longer necessary. For example, connection requests 158 and control data 140 may be deleted once a contract is closed, or after a threshold timeout interval.

Other modules 1140 may also be present in the memory 1120 as well as other data 1142 in the data store 1124.

The computing device 1100 may include a secure compute environment (SCE) 1150. The SCE 1150 may comprise one or more of a dedicated cryptographic processor, dedicated memory, and so forth. For example, the SCE may comprise a Trusted Platform Module (TPM) compliant with ISO/IEC 11889. In some implementations the SCE 1150 may be used to generate, store, or otherwise process cryptographic data 1152. The cryptographic data 1152 may be used to encrypt traffic, decrypt traffic, and so forth. For example, the cryptographic data 1152 may comprise one or more cryptographic keys.

The processes discussed herein may be implemented in hardware, software, or a combination thereof. In the context of software, the described operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising one or more platform computing devices, the one or more platform computing devices comprising:
a first communication interface;
a first set of one or more memories, storing first computer-executable instructions; and
a first set of one or more hardware processors to execute the first computer-executable instructions to:
receive (402) using the first communication interface, from an initiating node (104), a connection request (158) to establish a secure connection with a destination address;
determine (406) an initiating account associated with the connection request;
determine (408) the initiating account is associated with the connection request (158);
determine (412) a first set of node devices (106) that are available for use;
determine (414), based on the connection request (158), a first route using a subset of the first set of node devices (106);
determine (416), based on the first route, individual instances of route data (142);
determine (418), based on the first route, one or more instances of contract data (144);
determine (422) a plurality of instances of control data (140), each instance of control data (140) comprising the route data (142) and the contract data (144) associated with a respective one of the subset of the first set of node devices (106);
send (424), using the first communication interface, individual instances of the plurality of instances of control data (140) to respective ones of the subset of the first set of node devices (106);
determine (428) earned remuneration for one or more node devices of the subset of the first set of node devices (106); and
settle (430) remuneration between the initiating account and node accounts associated with individual ones of the subset of the first set of node devices (106).

2. The system of claim 1, further comprising:
the first set of one or more hardware processors to execute the first computer-executable instructions to:
determine a first set of latency data acquired by the first set of node devices (106);
determine, based on the first set of latency data, a first map; and
determine, based on the first map and using a bisection algorithm, the first route.

3. The system of claim 1, further comprising:
the first set of one or more hardware processors to execute the first computer-executable instructions to:
determine (410) connection parameters associated with the connection request, wherein the connection parameters are indicative of one or more of:
estimated duration of the secure connection,
estimated data transfer quantity,
requested egress location of the secure connection,
priority of the secure connection, or
remuneration tier; and
wherein one or more of the first route or the contract data (144) is based at least in part on the connection parameters.

4. The system of claim 1, further comprising:
the first set of one or more hardware processors to execute the first computer-executable instructions to:
receive (426) node data (178) from one or more of the subset of the first set of node devices (106), the node data (178) comprising one or more of:
external latency data between a node device and another network device,
node latency indicative of latency introduced during operation of the node device,
inbound available bandwidth,
outbound available bandwidth,
a contract identifier,
actual duration of the secure connection, or
quantity of data transferred by the secure connection; and
wherein the earned remuneration is based on the node data (178).

5. The system of claim 1, further comprising:
the first set of one or more hardware processors to execute the first computer-executable instructions to:
determine (404) available remuneration that is associated with the initiating account;
determine, based at least in part on the first route, contract escrow allocated remuneration for each node device (106) of the subset;
determine respective node escrow accounts associated with individual node devices (106) of the subset;
transfer, from the initiating account to the respective node escrow accounts, the contract escrow allocated remuneration;
determine the secure connection is terminated;
determine respective earned remuneration associated with each node device (106) of the subset;
determine respective node accounts associated with the node escrow accounts; and
transfer, from the respective node escrow accounts to the node accounts, the respective earned remuneration.

6. The system of claim 1, further comprising:
the first set of one or more hardware processors to execute the first computer-executable instructions to:
transfer (702), before initiating the secure connection, remuneration from the initiating account to an escrow account;
determine (704) a first set of valid contracts;
determine (706) earned remuneration that is associated with the subset of the first set of node devices (106);
determine (708) a first set of accounts associated with the subset of the first set of node devices (106);
transfer (710) the earned remuneration to respective ones of the first set of accounts;
determine (712) unearned remuneration that is associated with the subset of the first set of node devices (106); and
transfer (714) the unearned remuneration to the initiating account.

7. The system of claim 1, further comprising:
the first set of one or more hardware processors to execute the first computer-executable instructions to:
receive (802), from one or more of the subset of the first set of node devices (106), node data indicative of abuse associated with a contract identifier associated with the secure connection;
determine (804) the subset of the first set of node devices (106) that are associated with the contract identifier; and
send (806) second control data (140) to the subset of the first set of node devices (106) that are associated with the contract identifier, wherein the second control data (140) is indicative of termination of the secure connection associated with the contract identifier.

8. The system of claim 1, further comprising:
a first node device (102), wherein the first node device is in the first set of node devices (106), the first node device (102) comprising:
a second communication interface;
a second set of one or more memories, storing second computer-executable instructions; and
a second set of one or more hardware processors to execute the second computer-executable instructions to:
receive (904), using the second communication interface, first control data (140);
receive (906), using the second communication interface, encrypted traffic that is associated with the first control data; and
send (910), using the second communication interface, the encrypted traffic to a next address specified by the first control data (140).

9. The system of claim 1, further comprising:
a first node device (102), wherein the first node device is a member of the first set of node devices (106), the first node device (102) comprising:
a second communication interface;
a second set of one or more memories, storing second computer-executable instructions; and
a second set of one or more hardware processors to execute the second computer-executable instructions to:
receive (904), using the second communication interface, first control data (140);
receive (906), using the second communication interface, encrypted traffic that is associated with the first control data, wherein the encrypted traffic comprises a first packet received from a previous network address;
determine an incoming tuple associated with the first packet of the encrypted traffic, wherein the incoming tuple is indicative of one or more of a source network address, a source port, a destination network address, or a destination port;
form a user network socket in a user space of an operating system executing on the second set of one or more hardware processors;
determine an association between the tuple and the user network socket;
write the first packet to the user network socket;
send, after the write is complete, a response packet to the previous network address; and
send (910), from the user network socket and using the second communication interface, the first packet to a next address specified by the first control data (140).

10. The system of claim 1, further comprising:
a first node device (102), wherein the first node device is a member of the first set of node devices (106), the first node device (102) comprising:
a second communication interface;
a second set of one or more memories, storing second computer-executable instructions; and
a second set of one or more hardware processors to execute the second computer-executable instructions to:
receive, using the second communication interface, encrypted traffic (202) that is addressed to the one or more platform computing devices;
establish, using the second communication interface, an encrypted connection (204) with the one or more platform computing devices; and
send, using the second communication interface, the encrypted traffic (202) via the encrypted connection (204).

11. A computer-implemented method comprising:
receiving (402), from an initiating node (104), a connection request (158) to establish a secure connection with a destination address;
determining (408) an initiating account is associated with the connection request (158);
determining (412) a first set of node devices (106) that are available for use;
determining (414), based on the connection request (158), a first route using a subset of the first set of node devices (106);
determining (416), based on the first route, individual instances of route data (142);
determining (418), based on the first route, one or more instances of contract data (144);
determining (422) a plurality of instances of control data (140), each instance of control data (140) comprising the route data (142) and the contract data (144) associated with a respective one of the subset of the first set of node devices (106);
sending (424) individual instances of the plurality of instances of control data (140) to respective ones of the subset of the first set of node devices (106);
determining (428) earned remuneration for one or more node devices of the subset of the first set of node devices (106); and
settling (430) remuneration between the initiating account and node accounts associated with individual ones of the subset of the first set of node devices (106).

12. The method of claim 11, further comprising:
determining a first set of latency data acquired by the first set of node devices (106);
determining, based on the first set of latency data, a first map; and
determining, based on the first map and using a bisection algorithm, the first route.

13. The method of claim 11, further comprising:
determining (410) connection parameters associated with the connection request, wherein the connection parameters are indicative of one or more of:
estimated duration of the secure connection,
estimated data transferring quantity,
requested egress location of the secure connection,
priority of the secure connection, or
remuneration tier; and
wherein one or more of the first route or the contract data (144) is based at least in part on the connection parameters.

14. The method of claim 11, further comprising:
receiving (426) node data (178) from one or more of the subset of the first set of node devices (106), the node data (178) comprising one or more of:
external latency data between a node device and another network device,
node latency indicative of latency introduced during operation of the node device,
inbound available bandwidth,
outbound available bandwidth,
a contract identifier,
actual duration of the secure connection, or
quantity of data transferred by the secure connection; and
wherein the earned remuneration is based on the node data (178).

15. The method of claim 11, wherein the contract data (144) comprises one or more of:
a contract identifier indicative of the contract data (144),
estimated duration of the secure connection,
a remuneration tier that is associated with the secure connection, or
a maximum quantity of data to transfer.

16. The method of claim 11, further comprising:
determining (404) available remuneration that is associated with the initiating account;
determining, based at least in part on the first route, contract escrow allocated remuneration for each node device (106) of the subset;
determining respective node escrow accounts associated with individual node devices (106) of the subset;
transferring, from the initiating account to the respective node escrow accounts, the contract escrow allocated remuneration;
determining the secure connection is terminated;
determining respective earned remuneration associated with each node device (106) of the subset;
determining respective node accounts associated with the respective node escrow accounts; and
transferring, from the respective node escrow accounts to the respective node accounts, the respective earned remuneration.

17. The method of claim 11, further comprising:
transferring (702), before initiating the secure connection, remuneration from the initiating account to an escrow account;
determining (704) a first set of valid contracts;
determining (706) earned remuneration that is associated with the subset of the first set of node devices (106);
determining (708) a first set of accounts associated with the subset of the first set of node devices (106);
transferring (710) the earned remuneration to respective ones of the first set of accounts;
determining (712) unearned remuneration that is associated with the subset of the first set of node devices (106); and
transferring (714) the unearned remuneration to the initiating account.

18. The method of claim 11, further comprising:
receiving (802), from one or more of the subset of the first set of node devices (106), node data indicative of abuse associated with a contract identifier associated with the secure connection;
determining (804) the subset of the first set of node devices (106) that are associated with the contract identifier; and
sending (806) second control data (140) to the subset of the first set of node devices (106) that are associated with the contract identifier, wherein the second control data (140) is indicative of termination of the secure connection associated with the contract identifier.

19. The method of claim 11, further comprising:
at a first node device (102) that in the subset of the first set of node devices (106):
receiving first control data (140);
receiving encrypted traffic that is associated with the first control data; and
sending the encrypted traffic to a next address specified by the first control data (140).

20. The method of claim 11, further comprising:
at a first node device (102) that is in the subset of the first set of node devices (106):
receiving encrypted traffic (202) that is addressed to one or more platform computing devices;
establishing an encrypted connection (204) with the one or more platform computing devices; and
sending the encrypted traffic (202) via the encrypted connection (204).
